(19) United States
(12) Patent Application Publication
(10) Pub. No.: US 2023/0058319 A1
(43) Pub. Date: Feb. 23, 2023

(54) COMPOSITIONS AND METHODS FOR INHIBITION OF PATHOGENIC BACTERIA IN AQUACULTURE

(71) Applicant: BiOWiSH Technologies, Inc., Cincinnati, OH (US)

(72) Inventors: Richard S. CARPENTER, West Chester, OH (US); JoElla BARNES, Arcola, IL (US); John Kennedy CROCKETT, Kingsville, TX (US); Loc H. TRAN, Ho Chi Minh City (VN)

(21) Appl. No.: 17/786,322

(22) PCT Filed: Dec. 17, 2020
(86) PCT No.: PCT/US2020/065517

§ 371 Date: Jun. 16, 2022

Related U.S. Application Data
(60) Provisional application No. 62/949,589, filed on Dec. 18, 2019.

(51) Int. Cl. C02F 1/50; A23K 10/33; A23K 10/18; A23K 10/12

(52) U.S. Cl. CPC C02F 1/50; A23K 10/33; A23K 10/18; A23K 10/12

(57) ABSTRACT

One aspect of the invention relates to a composition comprising: water, soybean, molasses, a mineral mixture, an enzyme, and a microbial mixture comprising Bacillus subtilis 34KLB. Another aspect of the invention relates to a fermented composition of the above composition.

### RELATED APPLICATIONS

This application claims priority to and the benefit of U.S. Provisional Patent Application No. 62/949,589, filed on Dec. 18, 2019, the disclosure of which is hereby incorporated by reference in its entirety.

### INCORPORATION BY REFERENCE OF SEQUENCE LISTING

The contents of the text file named “BIOW-022P01US_Sequence_Listing.txt”, which was created on Nov. 15, 2019 and is 5.21 MB in size, are hereby incorporated by reference in their entirety.

### FIELD OF THE INVENTION

The present invention relates to compositions and methods used for inhibition of pathogenic bacteria in aquaculture.

### BACKGROUND OF THE INVENTION

Aquaculture is the farming of fish, shrimp, crustaceans, mollusks, aquatic plants, algae, and other organisms. Aquaculture involves cultivating freshwater and saltwater populations under controlled conditions, and can be contrasted with commercial fishing, which is the harvesting of wild fish. The global aquaculture market was valued at US $176.45 billion in 2017.

Currently, the shrimp industry is beset with disease and water quality issues. Adding to the situation is the need to increase stocking density and shorten grow out days of culture to compensate for increased populations and increasing consumption of seafood. Current strains of Post Larvae (PL) are bred to be specific pathogen free; however, they have slow growth rates. Newer hybrid strains that are fast growing are being introduced, but are susceptible to stressors, particularly transportation stress.

### SUMMARY OF THE INVENTION

Aspects of the current invention relate to fermented soy products and the use thereof to promote the growth of a healthy heterotrophic bacterial population in aquaculture (e.g., a pond) that can out-compete pathogenic bacterial growth. In addition, the fermented soy products described herein can have inhibitory effects on the growth of pathogenic bacteria including, but not limited to, Vibrio parahaemolyticus.

One aspect of the invention relates to a composition comprising: water, soybean, molasses, a mineral mixture, an enzyme, and a microbial mixture comprising Lactobacillus plantarum, Pediococcus acidilactici, Pediococcus pentosaceus, and Bacillus subtilis 34KLB.

In some embodiments, Lactobacillus plantarum, Pediococcus acidilactici, and Pediococcus pentosaceus are present at a ratio of about 1:1:1 by colony-forming unit (CFU).

In some embodiments, Lactobacillus plantarum, Pediococcus acidilactici, and Pediococcus pentosaceus are present in the microbial mixture at equal to or greater than 1×10⁸CFU per gram of the microbial mixture.

In some embodiments, Bacillus subtilis 34KLB is present in the microbial mixture at equal to or greater than 10⁶ CFU per gram of the microbial mixture.

In some embodiments, the microbial mixture further comprises a water-soluble diluent. In some embodiments, the water-soluble diluent is selected from dextrose monohydrate, anhydrous dextrose, sucrose, maltose, maltodextrin, sodium chloride, potassium chloride, calcium chloride, magnesium chloride, sodium sulfate, potassium sulfate, sodium bicarbonate, sodium carbonate, and magnesium sulfate. In some embodiments, the microbial mixture comprises about 95.45 wt % dextrose monohydrate, about 4 wt % diatomaceous earth, about 0.4 wt % of a mixture having Lactobacillus plantarum, Pediococcus acidilactici, and Pediococcus pentosaceus, and about 0.15 wt % Bacillus subtilis 34KLB.

In some embodiments, the mineral mixture comprises about 64.15 wt % dipotassium phosphate, about 20 wt % calcium propionate, about 4.5 wt % gemstone manganese, about 3.1 wt % gemstone iron, about 2.8 wt % gemstone copper, about 2.7 wt % gemstone zinc, about 2.67 wt % selenium yeast 3000, and about 0.08 wt % cobalt sulfate monohydrate.

In some embodiments, the enzyme is selected from phytase, protease, amylase, cellulase, cellobiohydrolase, endoglucanase, exoglucanase, and lipase.

In some embodiments, the soybean is raw soybean.

In some embodiments, the soybean is soybean meal.

In some embodiments, the weight ratio of water, raw soybean, molasses, the mineral mixture, and the microbial mixture is about 3000:1000:50:2.5:5.

In some embodiments, the weight ratio of water, soybean meal, molasses, the mineral mixture, and the microbial mixture is about 1000:167:1.25:0.003:0.013.

One aspect of the invention relates to a composition comprising: water, soybean, molasses, a mineral mixture, an enzyme, and a microbial mixture comprising a Bacillus composition.

In some embodiments, the Bacillus composition comprises Bacillus subtilis 34KLB.

In some embodiments, the Bacillus composition further comprises Bacillus amyloliquefaciens.

One aspect of the invention relates to a method of preparing a fermented composition of the soybean composition described herein, comprising: boiling the water in a container; adding the soybean and molasses to the boiling water; stirring the soybean and molasses for at least 20 minutes; cooling the soybean, molasses, and water to room temperature; mixing the mineral mixture, the enzyme, and the microbial mixture into the water, wherein the water is substantially free of stirring motions for at least 20 hours.

In some embodiments, the soybean and molasses are stirred for less than or equal to 30 minutes.

In some embodiments, the cooling step comprises contacting the container with ice.

In some embodiments, the water is substantially free of stirring motions for less than or equal to 48 hours.

One aspect of the invention relates to a fermented composition produced by the methods described herein.

One aspect of the invention relates to a method of inhibiting bacteria in water, the method comprising contacting water with a fermented composition described herein.

In some embodiments, the pathogenic bacteria is selected from Vibrio parahaemolyticus, Vibrio anguillarum, Vibrio harveyi. Vibrio vulnificus, Aliivibrio salmonicida, Photobacterium damselae, Aeromonas caviae, Aeromonas hydrophila, Aeromonas sobria, Aeromonas veronii, Aeromonas jandaei, Edwardsiella anguillarum, Edwardsiella ictaluri, Edwardsiella piscicida, Edwardsiella tarda, Yersinia ruckeri, Francisella noatunensis. Mycobacterium fortuitum, Mycobacterium marinum. Nocardia asteroidws, Nocardia crassostreae, Nocardia senolae, Streptococcus agalactiae, Streptococcus iniae, Lactococcus garvieae, Aerococcus viridans, Renibacterium salmoninarum, Enterobacterium catenabicterium, Clostridium botulinum. Piscirickettsia salmonis. Hepatobacter penaei, Francisella noatunensis, and Chlamydia spp.

In some embodiments, the water is used in aquaculture.

### BRIEF DESCRIPTION OF THE DRAWINGS

FIG. 1 shows fermentation of Bacillus subtilis 34KLB growth on tryptone soya agar (TSA).

FIG. 2 shows fermentation of lactic-acid-producing bacteria growth on De Man, Rogosa, and Sharpe (MRS) agar.

FIG. 3 is a graph showing how cooking of soybean meal and molasses reduces the background native microbial count as a function of time.

FIG. 4 shows inhibition of V. parahaemolyticus.

FIG. 5 shows inhibition of V. harveyi.

FIG. 6 shows inhibition of V. vulnificus.

FIG. 7 shows inhibition of V. cholera.

FIGS. 8A and 8B show inhibition of V. anguillarum.

FIG. 9 shows survival rate (%) 10-day post-challenge of LD₅₀ immersion challenge.

FIG. 10 shows survival rate (%) 10-day post-challenge of LD₈₀ immersion challenge.

### DETAILED DESCRIPTION OF THE INVENTION

One aspect of the present disclosure provides a composition comprising: water, soybean, molasses, a mineral mixture, an enzyme, and a microbial mixture that comprises a Bacillus composition.

In some embodiments, the soybean can include raw soybeans. In some embodiments, the soybean can include soybean meal. In some embodiments, the soybean can include a combination of raw soybeans and soybean meal.

In some embodiments, the soybean can have a weight percentage in the composition of at least about 10 wt %, at least about 12.5 wt %, at least about 15 wt %, at least about 17.5 wt %, at least about 20 wt %, at least about 22.5 wt %, at least about 25 wt %, or at least about 27.5 wt %. In some embodiments, the soybean can have a weight percentage in the composition of no more than about 45 wt %, no more than about 42.5 wt %, no more than about 40 wt %, no more than about 37.5 wt %, no more than about 35 wt %, no more than about 32.5 wt %, no more than about 30 wt %, no more than about 27.5 wt %, no more than about 25 wt %, no more than about 22.5 wt %, or no more than about 20 wt %.

Combinations of the above-referenced ranges for the weight percentage of the soybean are also possible (e.g., at least about 10 wt % to no more than about 45 wt %, or at least about 15 wt % to no more than about 40 wt %), inclusive of all values and ranges therebetween.

In some embodiments, the soybean can have a weight percentage in the composition of about 10 wt %, about 15 wt %, about 17.5 wt %, about 20 wt %, about 22.5 wt %, about 25 wt %, about 27.5 wt %, about 30 wt %, about 32.5 wt %, about 35 wt %, about 37.5 wt %, about 40 wt %, about 42.5 wt %, or about 45 wt %.

In some embodiments, the molasses can be pasteurized.

In some embodiments where raw soybeans are included in the composition, the molasses can have a weight percentage in the composition of at least about 0.5 wt %, at least about 0.6 wt %, at least about 0.7 wt %, at least about 0.8 wt %, at least about 0.9 wt %, at least about 1.0 wt %, at least about 1.1 wt %, at least about 1.2 wt %, or at least about 1.3 wt %. In some embodiments where raw soybeans are included in the composition, the molasses can have a weight percentage in the composition of no more than about 2.0 wt %, no more than about 1.9 wt %, no more than about 1.8 wt %, no more than about 1.7 wt %, no more than about 1.6 wt %, no more than about 1.5 wt %, no more than about 1.4 wt %, or no more than about 1.3 wt %.

Combinations of the above-referenced ranges for the weight percentage of the molasses in the composition having raw soybeans are also possible (e.g., at least about 0.5 wt % to no more than about 2.0 wt %, or at least about 1.0 wt % to no more than about 1.5 wt %), inclusive of all values and ranges therebetween.

In some embodiments where raw soybeans are included in the composition, the molasses can have a weight percentage in the composition of about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %.

In some embodiments where soybean meal is included in the composition, the molasses can have a weight percentage in the composition of at least about 0.05 wt %, at least about 0.06 wt %, at least about 0.07 wt %, at least about 0.08 wt %, at least about 0.09 wt %, at least about 0.1 wt %, at least about 0.11 wt %, at least about 0.12 wt %, or at least about or 0.13 wt %. In some embodiments where soybean meal is included in the composition, the molasses can have a weight percentage in the composition of no more than about 0.2 wt %, no more than about 0.19 wt %, no more than about 0.18 wt %, no more than about 0.17 wt %, no more than about 0.16 wt %, no more than about 0.15 wt %, no more than about 0.14 wt %, or no more than about 0.13 wt %.

Combinations of the above-referenced ranges for the molasses concentration where soybean meal is included in the composition are also possible (e.g., at least about 0.05 wt % to no more than about 0.2 wt %, or at least about 0.1 wt % to no more than about 0.15 wt %), inclusive of all values and ranges therebetween.

In some embodiments where soybean meal is included in the composition, the molasses can have a concentration of about 0.05 wt %, about 0.06 wt %, about 0.07 wt %, about 0.08 wt %, about 0.09 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, or about 0.2 wt %.

In some embodiments, the raw soybeans and molasses can be present in the composition at a weight ratio of at least about 5:1, at least about 10:1, at least about 15:1, at least about 20:1, at least about 25:1, at least about 30:1, or at least about 35:1. In some embodiments, the raw soybeans and molasses can be present in the composition at a weight ratio of no more than about 40:1, no more than about 35:1, no more than about 30:1, no more than about 25:1, no more than about 20:1, no more than about 15:1, or no more than about 10:1.

Combinations of the above-referenced ranges for the weight ratio of raw soybeans over molasses are also possible (e.g., at least about 5:1 to no more than about 40:1, or at least about 10:1 to no more than about 30:1), inclusive of all values and ranges therebetween.

In some embodiments, the raw soybeans and molasses can be present in the composition at a weight ratio of about 5:1, about 10:1, about 15:1, about 20:1, about 25:1, about 30:1, about 35:1, or about 40:1.

In some embodiments, the soybean meal and molasses can be present in the composition at a weight ratio of at least about 100:1, at least about 110:1, at least about 120:1, at least about 130:1, at least about 140:1, at least about 150:1, at least about 160:1, at least about 170:1, at least about 180:1, at least about 190:1, or at least about 200:1. In some embodiments, the soybean meal and molasses can be present in the composition at a weight ratio of no more than about 300:1, no more than about 290:1, no more than about 280:1, no more than about 270:1, no more than about 260:1, no more than about 250:1, no more than about 240:1, no more than about 230:1, no more than about 220:1, no more than about 210:1, or no more than about 200:1.

Combinations of the above-referenced ranges for the weight ratio of soybean meal over molasses are also possible (e.g., at least about 100:1 to no more than about 300:1, or at least about 150:1 to no more than about 250:1), inclusive of all values and ranges therebetween.

In some embodiments, the soybean meal and molasses can be present in the composition at a weight ratio of about 100:1, about 110:1, about 120:1, about 130:1, about 140:1, about 150:1, about 160:1, about 170:1, about 180:1, about 190:1, about 200:1, about 210:1, about 220:1, about 230:1, about 240:1, about 250:1, about 260:1, about 270:1, about 280:1, about 290:1, or about 300:1.

In some embodiments where raw soybeans are included in the composition, the mineral mixture can be present in the composition at a weight percentage of at least about 0.01 wt %, at least about 0.02 wt %, at least about 0.03 wt %, at least about 0.04 wt %, at least about 0.05 wt %, at least about 0.06 wt %, or at least about 0.07 wt %. In some embodiments where raw soybeans are included in the composition, the mineral mixture can be present in the composition at a weight percentage of no more than about 0.2 wt %, no more than about 0.19 wt %, no more than about 0.18 wt %, no more than about 0.17 wt %, no more than about 0.16 wt %, no more than about 0.15 wt %, no more than about 0.14 wt %, no more than about 0.13 wt %, no more than about 0.12 wt %, no more than about 0.11 wt %, or no more than about 0.10 wt %.

Combinations of the above-referenced ranges for the weight percentage of the mineral mixture in the composition where raw soybeans are included are also possible (e.g., at least about 0.01 wt % to no more than about 0.2 wt %, or at least about 0.15 wt % to no more than about 0.25 wt %), inclusive of all values and ranges therebetween.

In some embodiments where raw soybeans are included in the composition, the mineral mixture can be present in the composition at about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, or about 0.2 wt %.

In some embodiments where soybean meal is included in the composition, the mineral mixture can be present in the composition at a weight percentage of at least about 0.0001 wt %, at least about 0.00015 wt %, at least about 0.0002 wt %, at least about 0.00025 wt %, at least about 0.0003 wt %, at least about 0.00035 wt %, at least about 0.0004 wt %, or at least about 0.00045 wt %. In some embodiments where soybean meal is included in the composition, the mineral mixture can be present in the composition at a weight percentage of no more than about 0.0006 wt %, no more than about 0.0005 wt %, no more than about 0.00045 wt %, no more than about 0.0004 wt %, no more than about 0.00035 wt %, or no more than about 0.0003 wt %.

Combinations of the above-referenced ranges for the weight percentage of the mineral mixture in the composition where soybean meal is included are also possible (e.g., at least about 0.0001 wt % to no more than about 0.0006 wt %, or at least about 0.0002 wt % to no more than about 0.0004 wt %), inclusive of all values and ranges therebetween.

In some embodiments where soybean meal is included in the composition, the mineral mixture can be present in the composition at about 0.0001 wt %, about 0.00015 wt %, about 0.0002 wt %, about 0.00025 wt %, about 0.0003 wt %, about 0.00035 wt %, about 0.0004 wt %, about 0.00045 wt %, or about 0.0005 wt %.

In some embodiments, the mineral mixture can include dipotassium phosphate, calcium propionate, gemstone manganese, gemstone iron, gemstone copper, gemstone zinc, selenium yeast 3000, cobalt sulfate monohydrate, or any combination thereof.

In some embodiments, the mineral mixture can include at least about 50 wt % dipotassium phosphate, at least about 52 wt % dipotassium phosphate, at least about 54 wt % dipotassium phosphate, at least about 56 wt % dipotassium phosphate, at least about 58 wt % dipotassium phosphate, at least about 60 wt % dipotassium phosphate, at least about 62 wt % dipotassium phosphate, at least about 64 wt % dipotassium phosphate, at least about 66 wt % dipotassium phosphate, or at least about 68 wt % dipotassium phosphate. In some embodiments, the mineral mixture can include no more than about 70 wt % dipotassium phosphate, no more than about 68 wt % dipotassium phosphate, no more than about 66 wt % dipotassium phosphate, no more than about 64 wt % dipotassium phosphate, no more than about 62 wt % dipotassium phosphate, no more than about 60 wt % dipotassium phosphate, no more than about 58 wt % dipotassium phosphate, no more than about 56 wt % dipotassium phosphate, no more than about 54 wt % dipotassium phosphate, or no more than about 52 wt % dipotassium phosphate.

Combinations of the above-referenced ranges for the weight ratio of dipotassium phosphate in the mineral mixture are also possible (e.g., at least about 50 wt % to no more than about 70 wt %, or at least about 54 wt % to no more than about 66 wt %), inclusive of all values and ranges therebetween.

In some embodiments, the mineral mixture can include about 50 wt % dipotassium phosphate, about 52 wt % dipotassium phosphate, about 54 wt % dipotassium phosphate, about 56 wt % dipotassium phosphate, about 58 wt % dipotassium phosphate, about 60 wt % dipotassium phosphate, about 62 wt % dipotassium phosphate, about 64 wt % dipotassium phosphate, about 66 wt % dipotassium phosphate, about 68 wt % dipotassium phosphate, or about 70 wt % dipotassium phosphate.

In some embodiments, the mineral mixture can include at least about 10 wt % calcium propionate, at least about 12 wt % calcium propionate, at least about 14 wt % calcium propionate, at least about 16 wt % calcium propionate, at least about 18 wt % calcium propionate, at least about 20 wt % calcium propionate, at least about 22 wt % calcium propionate, at least about 24 wt % calcium propionate, at least about 26 wt % calcium propionate, or at least about 28 wt % calcium propionate. In some embodiments, the mineral mixture can include no more than about 30 wt % calcium propionate, no more than about 28 wt % calcium propionate, no more than about 26 wt % calcium propionate, no more than about 24 wt % calcium propionate, no more than about 22 wt % calcium propionate, no more than about 20 wt % calcium propionate, no more than about 18 wt % calcium propionate, no more than about 16 wt % calcium propionate, no more than about 14 wt % calcium propionate, or no more than about 12 wt % calcium propionate.

Combinations of the above-referenced ranges for the weight ratio of calcium propionate in the mineral mixture are also possible (e.g., at least about 12 wt % to no more than about 30 wt %, or at least about 14 wt % to no more than about 28 wt %), inclusive of all values and ranges therebetween.

In some embodiments, the mineral mixture can include about 10 wt % calcium propionate, about 12 wt % calcium propionate, about 14 wt % calcium propionate, about 16 wt % calcium propionate, about 18 wt % calcium propionate, about 20 wt % calcium propionate, about 22 wt % calcium propionate, about 24 wt % calcium propionate, about 26 wt % calcium propionate, about 28 wt % calcium propionate, or about 30 wt % calcium propionate.

In some embodiments, the mineral mixture can include at least about 2 wt % gemstone manganese, at least about 2.5 wt % gemstone manganese, at least about 3 wt % gemstone manganese, at least about 3.5 wt % gemstone manganese, at least about 4 wt % gemstone manganese, at least about 4.5 wt % gemstone manganese, at least about 5 wt % gemstone manganese, at least about 5.5 wt % gemstone manganese, at least about 6 wt % gemstone manganese, at least about 6.5 wt % gemstone manganese. In some embodiments, the mineral mixture can include no more than about 7 wt % gemstone manganese, no more than about 6.5 wt % gemstone manganese, no more than about 6 wt % gemstone manganese, no more than about 5.5 wt % gemstone manganese, no more than about 5 wt % gemstone manganese, no more than about 4.5 wt % gemstone manganese, no more than about 4 wt % gemstone manganese, no more than about 3.5 wt % gemstone manganese, no more than about 3 wt % gemstone manganese, or no more than about 2.5 wt % gemstone manganese.

Combinations of the above-referenced ranges for the weight ratio of gemstone manganese in the mineral mixture are also possible (e.g., at least about 2 wt % to no more than about 7 wt %, or at least about 3 wt % to no more than about 6 wt %), inclusive of all values and ranges therebetween.

In some embodiments, the mineral mixture can include about 2 wt % gemstone manganese, about 2.5 wt % gemstone manganese, about 3 wt % gemstone manganese, about 3.5 wt % gemstone manganese, about 4 wt % gemstone manganese, about 4.5 wt % gemstone manganese, about 5 wt % gemstone manganese, about 5.5 wt % gemstone manganese, about 6 wt % gemstone manganese, about 6.5 wt % gemstone manganese, or about 7 wt % gemstone manganese.

In some embodiments, the mineral mixture can include at least about 2 wt % gemstone iron, at least about 2.2 wt % gemstone iron, at least about 2.4 wt % gemstone iron, at least about 2.6 wt % gemstone iron, at least about 2.8 wt % gemstone iron, at least about 3 wt % gemstone iron, at least about 3.1 wt % gemstone iron, at least about 3.2 wt % gemstone iron, at least about 3.4 wt % gemstone iron, at least about 3.6 wt % gemstone iron, or at least about 3.8 wt % gemstone iron. In some embodiments, the mineral mixture can include no more than about 4 wt % gemstone iron, no more than about 3.8 wt % gemstone iron, no more than about 3.6 wt % gemstone iron, no more than about 3.4 wt % gemstone iron, no more than about 3.2 wt % gemstone iron, no more than about 3.1 wt % gemstone iron, no more than about 3 wt % gemstone iron, no more than about 2.8 wt % gemstone iron, no more than about 2.6 wt % gemstone iron, no more than about 2.4 wt % gemstone iron, or no more than about 2.2 wt % gemstone iron.

Combinations of the above-referenced ranges for the weight ratio of gemstone iron in the mineral mixture are also possible (e.g., at least about 2 wt % to no more than about 4 wt %, or at least about 2.2 wt % to no more than about 3.8 wt %), inclusive of all values and ranges therebetween.

In some embodiments, the mineral mixture can include about 2 wt % gemstone iron, about 2.2 wt % gemstone iron, about 2.4 wt % gemstone iron, about 2.6 wt % gemstone iron, about 2.8 wt % gemstone iron, about 3 wt % gemstone iron, about 3.1 wt % gemstone iron, about 3.2% gemstone iron, about 3.4% gemstone iron, about 3.6% gemstone iron, about 3.8 wt % gemstone iron, or about 4 wt % gemstone iron.

In some embodiments, the mineral mixture can include at least about 2 wt % gemstone copper, at least about 2.2 wt % gemstone copper, at least about 2.4 wt % gemstone copper, at least about 2.6 wt % gemstone copper, at least about 2.8 wt % gemstone copper, at least about 3 wt % gemstone copper, at least about 3.2 wt % gemstone copper, at least about 3.4 wt % gemstone copper, at least about 3.6 wt % gemstone copper, or at least about 3.8 wt % gemstone copper. In some embodiments, the mineral mixture can include no more than about 4 wt % gemstone copper, no more than about 3.8 wt % gemstone copper, no more than about 3.6 wt % gemstone copper, no more than about 3.4 wt % gemstone copper, no more than about 3.2 wt % gemstone copper, no more than about 3 wt % gemstone copper, no more than about 2.8 wt % gemstone copper, no more than about 2.6 wt % gemstone copper, no more than about 2.4 wt % gemstone copper, or no more than about 2.2 wt % gemstone copper.

Combinations of the above-referenced ranges for the weight ratio of gemstone copper in the mineral mixture are also possible (e.g., at least about 2 wt % to no more than about 4 wt %, or at least about 2.2 wt % to no more than about 3.8 wt %), inclusive of all values and ranges therebetween.

In some embodiments, the mineral mixture can include about 2 wt % gemstone copper, about 2.2 wt % gemstone copper, about 2.4 wt % gemstone copper, about 2.6 wt % gemstone copper, about 2.8 wt % gemstone copper, about 3 wt % gemstone copper, about 3.2 wt % gemstone copper, about 3.4 wt % gemstone copper, about 3.6 wt % gemstone copper, about 3.8 wt % gemstone copper, or about 4 wt % gemstone copper.

In some embodiments, the mineral mixture can include at least about 2 wt % gemstone zinc, at least about 2.2 wt % gemstone zinc, at least about 2.4 wt % gemstone zinc, at least about 2.6 wt % gemstone zinc, at least about 2.7 wt % gemstone zinc, at least about 2.8 wt % gemstone zinc, at least about 3 wt % gemstone zinc, at least about 3.2 wt % gemstone zinc, at least about 3.4 wt % gemstone zinc, at least about 3.6 wt % gemstone zinc, at least about 3.8 wt % gemstone zinc. In some embodiments, the mineral mixture can include no more than about 4 wt % gemstone zinc, no more than about 3.8 wt % gemstone zinc, no more than about 3.6 wt % gemstone zinc, no more than about 3.4 wt % gemstone zinc, no more than about 3.2 wt % gemstone zinc, no more than about 3 wt % gemstone zinc, no more than about 2.8 wt % gemstone zinc, no more than about 2.7 wt % gemstone zinc, no more than about 2.6 wt % gemstone zinc, no more than about 2.4 wt % gemstone zinc, or no more than about 2.2 wt % gemstone zinc.

Combinations of the above-referenced ranges for the weight ratio of gemstone zinc in the mineral mixture are also possible (e.g., at least about 2 wt % to no more than about 4 wt %, or at least about 2.2 wt % to no more than about 3.8 wt %), inclusive of all values and ranges therebetween.

In some embodiments, the mineral mixture can include about 2 wt % gemstone zinc, about 2.2 wt % gemstone zinc, about 2.4 wt % gemstone zinc, about 2.6 wt % gemstone zinc, about 2.7 wt % gemstone zinc, about 2.8 wt % gemstone zinc, about 3 wt % gemstone zinc, about 3.2 wt % gemstone zinc, about 3.4 wt % gemstone zinc, about 3.6 wt % gemstone zinc, about 3.8 wt % gemstone zinc, or about 4 wt % gemstone zinc.

In some embodiments, the mineral mixture can include at least about 2 wt % selenium yeast 3000, at least about 2.2 wt % selenium yeast 3000, at least about 2.4 wt % selenium yeast 3000, at least about 2.6 wt % selenium yeast 3000, at least about 2.67 wt % selenium yeast 3000, at least about 2.8 wt % selenium yeast 3000, at least about 3 wt % selenium yeast 3000, at least about 3.2 wt % selenium yeast 3000, at least about 3.4 wt % selenium yeast 3000, at least about 3.6 wt % selenium yeast 3000, at least about 3.8 wt % selenium yeast 3000. In some embodiments, the mineral mixture can include no more than about 4 wt % selenium yeast 3000, no more than about 3.8 wt % selenium yeast 3000, no more than about 3.6 wt % selenium yeast 3000, no more than about 3.4 wt % selenium yeast 3000, no more than about 3.2 wt % selenium yeast 3000, no more than about 3 wt % selenium yeast 3000, no more than about 2.8 wt % selenium yeast 3000, no more than about 2.67 wt % selenium yeast 3000, no more than about 2.6 wt % selenium yeast 3000, no more than about 2.4 wt % selenium yeast 3000, or no more than about 2.2 wt % selenium yeast 3000.

Combinations of the above-referenced ranges for the weight ratio of selenium yeast 3000 in the mineral mixture are also possible (e.g., at least about 2 wt % to no more than about 4 wt %, or at least about 2.2 wt % to no more than about 3.8 wt %), inclusive of all values and ranges therebetween.

In some embodiments, the mineral mixture can include about 2 wt % selenium yeast 3000, about 2.2 wt % selenium yeast 3000, about 2.4 wt % selenium yeast 3000, about 2.6 wt % selenium yeast 3000, about 2.67 wt % selenium yeast 3000, about 2.8 wt % selenium yeast 3000, about 3 wt % selenium yeast 3000, about 3.2 wt % selenium yeast 3000, about 3.4 wt % selenium yeast 3000, about 3.6 wt % selenium yeast 3000, about 3.8 wt % selenium yeast 3000, or about 4 wt % selenium yeast 3000.

In some embodiments, the mineral mixture can include at least about 0.01 wt % cobalt sulfate monohydrate, at least about 0.02 wt % cobalt sulfate monohydrate, at least about 0.03 wt % cobalt sulfate monohydrate, at least about 0.04 wt % cobalt sulfate monohydrate, at least about 0.05 wt % cobalt sulfate monohydrate, at least about 0.06 wt % cobalt sulfate monohydrate, at least about 0.07 wt % cobalt sulfate monohydrate, at least about 0.08 wt % cobalt sulfate monohydrate, at least about 0.09 wt % cobalt sulfate monohydrate, or at least about 0.1 wt % cobalt sulfate monohydrate. In some embodiments, the mineral mixture can include no more than about 0.15 wt % cobalt sulfate monohydrate, no more than about 0.1 wt % cobalt sulfate monohydrate, no more than about 0.09 wt % cobalt sulfate monohydrate, no more than about 0.08 wt % cobalt sulfate monohydrate, no more than about 0.07 wt % cobalt sulfate monohydrate, no more than about 0.06 wt % cobalt sulfate monohydrate, no more than about 0.05 wt % cobalt sulfate monohydrate, no more than about 0.04 wt % cobalt sulfate monohydrate, no more than about 0.03 wt % cobalt sulfate monohydrate, or no more than about 0.02 wt % cobalt sulfate monohydrate.

Combinations of the above-referenced ranges for the weight ratio of cobalt sulfate monohydrate in the mineral mixture are also possible (e.g., at least about 0.01 wt % to no more than about 0.15 wt %, or at least about 0.05 wt % to no more than about 0.1 wt %), inclusive of all values and ranges therebetween.

In some embodiments, the mineral mixture can include about 0.01 wt % cobalt sulfate monohydrate, about 0.02 wt %,% cobalt sulfate monohydrate, about 0.03 wt % cobalt sulfate monohydrate, about 0.04 wt % cobalt sulfate monohydrate, about 0.05 wt % cobalt sulfate monohydrate, about 0.06 wt % cobalt sulfate monohydrate, about 0.07 wt %,% cobalt sulfate monohydrate, about 0.08 wt % cobalt sulfate monohydrate, about 0.09 wt % cobalt sulfate monohydrate, about 0.1 wt % cobalt sulfate monohydrate, or about 0.15 wt % cobalt sulfate monohydrate.

In some embodiments, the enzyme can include phytase, protease, amylase, cellobiohydrolase, endoglucanase, exoglucanase, lipase, or any combination thereof. In some embodiments, the enzyme can be in the form of a dried powder, wherein the dried powder includes the enzyme and a diluent. In some embodiments, the dried powder can have a weight percentage in the composition of at least about 0.01 wt %, at least about 0.02 wt %, at least about 0.03 wt %, at least about 0.04 wt %, at least about 0.05 wt %, at least about 0.06 wt %, at least about 0.07 wt %, at least about 0.08 wt %, at least about 0.09 wt %, at least about 0.1 wt %, at least about 0.11 wt %, at least about 0.12 wt %, at least about 0.13 wt %, at least about 0.14 wt %, at least about 0.15 wt %, at least about 0.16 wt %, at least about 0.17 wt %, at least about 0.18 wt %, or at least about 0.19 wt %. In some embodiments, the dried powder can have a weight percentage in the composition of no more than about 0.2 wt %, no more than about 0.19 wt %, no more than about 0.18 wt %, no more than about 0.17 wt %, no more than about 0.16 wt %, no more than about 0.15 wt %, no more than about 0.14 wt %, no more than about 0.13 wt %, no more than about 0.12 wt %, no more than about 0.11 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, or no more than about 0.02 wt %.

Combinations of the above-referenced ranges for the weight percentage of the dried powder in the composition are also possible (e.g., at least about 0.01 wt % to no more than about 0.2 wt %, or at least about 0.05 wt % to no more than about 0.15 wt %), inclusive of all values and ranges therebetween.

In some embodiments, the dried powder can have a weight percentage in the composition of about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, or about 0.2 wt %.

In some embodiments, the microbial mixture can further include a mixture of lactic-acid-producing bacteria. The mixture of lactic-acid-producing bacteria can include Lactobacillus plantarum, Pediococcus acidilactici, Pediococcus pentosaceus, or any combination thereof. In some embodiments, the mixture of lactic-acid-producing bacteria can include Lactobacillus plantarum, Pediococcus acidilactici, and Pediococcus pentosaceus. In some embodiments, the Lactobacillus plantarum, Pediococcus acidilactici, and Pediococcus pentosaceus can be present at a ratio of about 1:1:1 by CFU.

In some embodiments, the mixture of lactic-acid-producing bacteria can have a total microbial titer (i.e., inclusive of each lactic-acid-producing bacteria species) in the microbial mixture of at least about 1*10¹⁰ CFU/g, at least about 2*10¹⁰ CFU/g, at least about 3*10¹⁰ CFU/g, at least about 4*10¹⁰ CFU/g, at least about 5*10¹⁰ CFU/g, at least about 6*10¹⁰ CFU/g, at least about 7*10¹⁰ CFU/g, at least about 8*10¹⁰ CFU/g, at least about 9*10¹⁰ CFU/g, at least about 1*10¹¹ CFU/g, at least about 1.1*10¹¹ CFU/g, at least about 1.2*10¹¹ CFU/g, at least about 1.3*10¹¹ CFU/g, at least about 1.4*10¹¹ CFU/g, at least about 1.5*10¹¹ CFU/g, at least about 1.6*10¹¹ CFU/g, at least about 1.7*10¹¹ CFU/g, at least about 1.8*10¹¹ CFU/g, at least about 1.9*10¹¹ CFU/g, or at least about 2*10¹¹ CFU/g. In some embodiments, the mixture of lactic-acid-producing bacteria can have a total microbial titer (i.e., inclusive of each lactic-acid-producing bacteria species) in the microbial mixture of no more than about 1*10¹³ CFU/g, no more than about 1*10¹² CFU/g, no more than about 5*10¹¹ CFU/g, no more than about 4*10¹¹ CFU/g, no more than about 3*10¹¹ CFU/g, or no more than about 2*10¹¹ CFU/g.

Combinations of the above-referenced ranges for the lactic-acid-producing bacteria concentration are also possible (e.g., at least about 1*10¹⁰ CFU/g to no more than about 1*10¹³ CFU/g, or at least about 2*10¹⁰ CFU/g to no more than about 1*10¹² CFU/g), inclusive of all values and ranges therebetween.

In some embodiments, the Bacillus composition can include Bacillus subtilis (e.g., Bacillus subtilis 34KLB), Bacillus lichenmforis, Bacillus pumilus, Bacillus amyloliquefaciens, Bacillus mojavensis, or any combination thereof. In some embodiments, the Bacillus composition consists of Bacillus subtilis 34KLB. In some embodiments, the Bacillus composition includes Bacillus subtilis 34KLB and Bacillus amyloliquefaciens.

The sequence of Bacillus subtilis 34 KLB can include one or a combination of SEQ ID NOs. 1-18. Table 1 includes the Bacillus subtilis 34 KLB contig numbers in relation to SEQ ID NOs. The contig numbers and the related sequences are produced from sequencing the Bacillus subtilis 34 KLB genome. In some embodiments, the genome sequence of Bacillus subtilis 34 KLB can include all the sequences in Table 1. In some embodiments, the genome sequence of Bacillus subtilis 34 KLB can include all the sequences in Table 1 in the order specified by the contig numbers.

TABLE 1
Contig number ordering

| SEQ ID NO | Contig Number |
|---|---|
| 1 | 19 |
| 2 | 11 |
| 3 | 18 |
| 4 | 14 |
| 5 | 22 |
| 6 | 21 |
| 7 | 3 |
| 8 | 9 |
| 9 | 2 |
| 10 | 10 |
| 11 | 13 |
| 12 | 6 |
| 13 | 15 |
| 14 | 5 |
| 15 | 4 |
| 16 | 1 |
| 17 | 16 |
| 18 | 20 |

In some embodiments, the sequence of Bacillus subtilis 34 KLB can include a sequence that is at least about 95%, at least about 95.2%, at least about 95.4%, at least about 95.6%, at least about 95.8%, at least about 96%, at least about 96.2%, at least about 96.4%, at least about 96.6%, at least about 96.8%, at least about 97%, at least about 97.2%, at least about 97.4%, at least about 97.6%, at least about 97.8%, at least about 98%, at least about 98.2%, at least about 98.4%, at least about 98.6%, at least about 98.8%, or at least about 99% similar to a sequence selected from SEQ ID No. 1-18.

In some embodiments, the Bacillus composition can have a total microbial titer (i.e., inclusive of each Bacillus species) in the microbial mixture of at least about 1*10⁶ CFU/g, at least about 1*10⁷ CFU/g, at least about 1*10⁸ CFU/g, at least about 1*10⁹ CFU/g, at least about 1*10¹⁰ CFU/g, at least about 2*10¹⁰ CFU/g, at least about 3*10¹⁰ CFU/g, at least about 4*10¹⁰ CFU/g, at least about 5*10¹⁰ CFU/g, at least about 6*10¹⁰ CFU/g, at least about 7*10¹⁰ CFU/g, at least about 8*10¹⁰ CFU/g, at least about 9*10¹⁰ CFU/g, at least about 1*10¹⁰ CFU/g, at least about 1.1*10¹¹ CFU/g, at least about 1.2*10¹¹ CFU/g, at least about 1.3*10¹¹ CFU/g, at least about 1.4*10¹¹ CFU/g, at least about 1.5*10¹¹ CFU/g, at least about 1.6*10¹¹ CFU/g, at least about 1.7*10¹¹ CFU/g, at least about 1.8*10¹¹ CFU/g, at least about 1.9*10¹¹ CFU/g, or at least about 2*10¹¹ CFU/g.

In some embodiments, the Bacillus composition can have a total microbial titer (i.e., inclusive of each Bacillus species) in the microbial mixture of no more than about 1*10¹² CFU/g, no more than about 5*10¹¹ CFU/g, no more than about 1*10¹¹ CFU/g, no more than about 9*10¹⁰ CFU/g, no more than about 8*10¹⁰ CFU/g, no more than about 7*10¹⁰ CFU/g, no more than about 6*10¹⁰ CFU/g, no more than about 5*10¹⁰ CFU/g, no more than about 4*10¹⁰ CFU/g, no more than about 3*10¹⁰ CFU/g, no more than about 2*10¹⁰ CFU/g, or no more than about 1*10¹⁰ CFU/g.

Combinations of the above-referenced ranges for the Bacillus concentration are also possible (e.g., at least about 1*10¹¹ CFU/g to no more than about 1*10¹² CFU/g, or at least about 1*10⁷ CFU/g to no more than about 1*10¹¹ CFU/g), inclusive of all values and ranges therebetween.

In some embodiments where raw soybeans are included in the composition, the microbial mixture can have a weight percentage in the composition of at least about 0.05 wt %, at least about 0.1 wt %, at least about 0.15 wt %, at least about 0.2 wt %, at least about 0.25 wt %, at least about 0.3 wt %, at least about 0.35 wt %, at least about 0.4 wt %, at least about 0.45 wt %, at least about 0.5 wt %, at least about 0.55 wt %, at least about 0.6 wt %, at least about 0.65 wt %. In some embodiments where raw soybeans are included in the composition, the microbial mixture can have a weight percentage in the composition of no more than about 0.7 wt %, no more than about 0.65 wt %, no more than about 0.6 wt %, no more than about 0.55 wt %, no more than about 0.5 wt %, no more than about 0.45 wt %, no more than about 0.4 wt %, no more than about 0.35 wt %, no more than about 0.3 wt %, no more than about 0.25 wt %, no more than about 0.2 wt %, or no more than about 0.1 wt %.

Combinations of the above-referenced ranges for the weight percentage of the microbial mixture in the composition where raw soybeans are included are also possible (e.g., at least about 0.05 wt % to no more than about 0.7 wt %, or at least about 0.1 wt % to no more than about 0.5 wt %), inclusive of all values and ranges therebetween.

In some embodiments where raw soybeans are included in the composition, the microbial mixture can have a weight percentage in the composition of about 0.05 wt %, about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, or about 0.7 wt %.

In some embodiments where soybean meal is included in the composition, the microbial mixture can have a weight percentage in the composition of at least about 0.0005 wt %, at least about 0.0006 wt %, at least about 0.0007 wt %, at least about 0.0008 wt %, at least about 0.0009 wt %, at least about 0.001 wt %, at least about 0.0011 wt %, at least about 0.0012 wt %, at least about 0.0013 wt %, at least about 0.0014 wt %, at least about 0.0015 wt %, at least about 0.0016 wt %, at least about 0.0017 wt %, at least about 0.0018 wt %, or at least about 0.0019 wt %. In some embodiments where soybean meal is included in the composition, the microbial mixture can have a weight percentage in the composition of no more than about 0.002 wt %, no more than about 0.0019 wt %, no more than about 0.0018 wt %, no more than about 0.0017 wt %, no more than about 0.0016 wt %, no more than about 0.0015 wt %, no more than about 0.0014 wt %, no more than about 0.0013 wt %, no more than about 0.0012 wt %, no more than about 0.0011 wt %, no more than about 0.001 wt %, no more than about 0.0009 wt %, no more than about 0.0008 wt %, no more than about 0.0007 wt %, or no more than about 0.0006 wt %.

Combinations of the above-referenced ranges for the weight percentage of the microbial mixture the composition where soybean meal is included are also possible (e.g., at least about 0.0005 wt % to no more than about 0.002 wt %, or at least about 0.001 wt % to no more than about 0.0015 wt %), inclusive of all values and ranges therebetween.

In some embodiments where soybean meal is included in the composition, the microbial mixture can have a weight percentage in the composition of about 0.0005 wt %, about 0.0006 wt %, about 0.0007 wt %, about 0.0008 wt %, about 0.0009 wt %, about 0.001 wt %, about 0.0011 wt %, about 0.0012 wt %, about 0.0013 wt %, about 0.0014 wt %, about 0.0015 wt %, about 0.0016 wt %, about 0.0017 wt %, about 0.0018 wt %, about 0.0019 wt %, or about 0.002 wt %.

In some embodiments, the microbial mixture can include a water-soluble diluent. In some embodiments, the water-soluble diluent can include dextrose monohydrate, diatomaceous earth, anhydrous dextrose, sucrose, maltose, maltodextrin, sodium chloride, potassium chloride, calcium chloride, magnesium chloride, sodium sulfate, potassium sulfate, magnesium sulfate, oat beta glucan, potassium carbonate, sodium bicarbonate, and sodium carbonate, or any combination thereof. In some embodiments, the water-soluble diluent can include dextrose monohydrate and diatomaceous earth.

In some embodiments, the microbial mixture can include at least about 80 wt % water-soluble diluent, at least about 85 wt % water-soluble diluent, at least about 90 wt % water-soluble diluent, or at least about 95 wt % water-soluble diluent. In some embodiments, the microbial mixture can include no more than about 99 wt % water-soluble diluent, no more than about 98 wt % water-soluble diluent, no more than about 97 wt % water-soluble diluent, no more than about 96 wt % water-soluble diluent, no more than about 95 wt % water-soluble diluent, no more than about 94 wt % water-soluble diluent, no more than about 93 wt % water-soluble diluent, no more than about 92 wt % water-soluble diluent, or no more than about 91 wt % water-soluble diluent.

Combinations of the above-referenced ranges for the weight percentage of water-soluble diluent in the microbial mixture are also possible (e.g., at least about 80 wt % to no more than about 99 wt %, or at least about 85 wt % to no more than about 95 wt %), inclusive of all values and ranges therebetween.

In some embodiments, the microbial mixture can include about 90 wt % water-soluble diluent, about 91 wt % water-soluble diluent, about 92 wt % water-soluble diluent, about 93 wt % water-soluble diluent, about 94 wt % water-soluble diluent, about 95 wt % water-soluble diluent, about 96 wt % water-soluble diluent, about 97 wt % water-soluble diluent, about 98 wt % water-soluble diluent, or about 99 wt % water-soluble diluent.

In some embodiments, the weight ratio of water, raw soybean, molasses, the mineral mixture, and the microbial mixture can be about 3000:1000:50:2.5:5. In some embodiments, the weight ratio of water, soybean meal, molasses, the mineral mixture, and the microbial mixture can be about 1000:167:1.25:0.003:0.013.

One aspect of the disclosure relates to a method of preparing a fermented composition of the composition described herein, comprising: boiling the water in a container; adding the soybean and molasses to the boiling water; stirring the soybean and molasses in the water; cooling the soybean, molasses, and water to room temperature; mixing the mineral mixture, the enzyme, and the microbial mixture into the water, wherein the water is substantially free of stirring motions for a time period.

In some embodiments, the soybean and molasses can be stirred in the boiling water for at least about 5 minutes, at least about 10 minutes, at least about 15 minutes, at least about 20 minutes, at least about 25 minutes, at least about 30 minutes, at least about 35 minutes, at least about 40 minutes, or at least about 45 minutes. In some embodiments, the soybean and molasses can be stirred in the water for less than about 60 minutes, less than about 40 minutes, less than about 35 minutes, less than about 30 minutes, less than about 20 minutes, less than about 15 minutes, less than about 10 minutes, or less than about 5 minutes.

Combinations of the above-referenced ranges for the stirring time are also possible (e.g., at least about 5 minutes to less than about 60 minutes, or at least about 20 minutes to less than about 40 minutes), inclusive of all values and ranges therebetween.

In some embodiments, the soybean and molasses can be stirred in the water for about 5 minutes, about 10 minutes, about 15 minutes, about 20 minutes, about 25 minutes, about 30 minutes, about 35 minutes, about 40 minutes, or about 45 minutes.

In some embodiments, the soybean, molasses, and water can be cooled to room temperature over a time period of at least about 1 minute, at least about 2 minutes, at least about 3 minutes, at least about 4 minutes, at least about 5 minutes, at least about 10 minutes, at least about 15 minutes, at least about 20 minutes, at least about 25 minutes, at least about 30 minutes, at least about 35 minutes, or at least about 40 minutes. In some embodiments, the soybean, molasses, and water can be cooled to room temperature over a time period of no more than about 45 minutes, no more than about 40 minutes, no more than about 35 minutes, no more than about 30 minutes, no more than about 25 minutes, no more than about 20 minutes, no more than about 15 minutes, no more than about 10 minutes, no more than about 5 minutes, no more than about 4 minutes, no more than about 3 minutes, no more than about 2 minutes.

Combinations of the above-referenced ranges for the time period for cooling are also possible (e.g., at least about 1 minute to no more than about 45 minutes, or at least about 5 minutes to no more than about 40 minutes), inclusive of all values and ranges therebetween.

In some embodiments, the soybean, molasses, and water can be cooled to room temperature over a time period of about 1 minute, about 2 minutes, about 3 minutes, about 4 minutes, about 5 minutes, about 10 minutes, about 15 minutes, about 20 minutes, about 25 minutes, about 30 minutes, about 35 minutes, about 40 minutes, or about 45 minutes. In some embodiments, the soybean, molasses, and water can be cooled to room temperature in the presence of ice or cooling water.

In some embodiments, the mineral mixture, enzyme, and microbial mixture can be added to the soybean, molasses, and water before cooling the soybean, molasses, and water to room temperature. In some embodiments, the mineral mixture, enzyme, and microbial mixture can be added to the soybean, molasses, and water after cooling the soybean, molasses, and water to room temperature.

After the mineral mixture, enzyme, and microbial mixture are added to the soybean, molasses, and water, the water is substantially free of stirring motions for a time period of at least about 5 hours, at least about 10 hours, at least about 15 hours, at least about 20 hours, at least about 25 hours, at least about 30 hours, at least about 35 hours, at least about 40 hours, or at least about 45 hours. In some embodiments, the water can be substantially free of stirring motions for a time period of no more than about 48 hours, no more than about 45 hours, no more than about 40 hours, no more than about 35 hours, no more than about 30 hours, no more than about 25 hours, no more than about 20 hours, no more than about 15 hours, or no more than about 10 hours.

Combinations of the above-referenced ranges for the time period for being substantially free of stirring motions are also possible (e.g., at least about 5 hours to no more than about 48 hours, or at least about 10 hours to no more than about 40 hours), inclusive of all values and ranges therebetween.

In some embodiments, the water can be substantially free of stirring motions for a time period of about 5 hours, about 10 hours, about 15 hours, about 20 hours, about 25 hours, about 30 hours, about 35 hours, about 40 hours, about 45 hours, or about 48 hours.

In some embodiments, the method of preparing the fermented composition can include storing the composition for an incubation period, during which the composition can ferment. In some embodiments, the incubation period can be at least about 5 hours, at least about 10 hours, at least about 15 hours, at least about 20 hours, at least about 25 hours, at least about 30 hours, at least about 35 hours, at least about 40 hours, at least about 45 hours, at least about 50 hours, at least about 55 hours, at least about 60 hours, at least about 65 hours, or at least about 70 hours. In some embodiments, the incubation period can be no more than about 72 hours, no more than about 70 hours, no more than about 65 hours, no more than about 60 hours, no more than about 55 hours, no more than about 50 hours, no more than about 45 hours, no more than about 40 hours, no more than about 35 hours, no more than about 30 hours, no more than about 25 hours, no more than about 20 hours, no more than about 15 hours, no more than about 10 hours, or no more than about 10 hours.

Combinations of the above-referenced time ranges of the incubation period are also possible (e.g., at least about 5 hours to no more than about 72 hours, or at least about 10 hours to no more than about 65 hours), inclusive of all values and ranges therebetween.

In some embodiments, the incubation period can be about 5 hours, about 10 hours, about 15 hours, about 20 hours, about 24 hours, about 25 hours, about 30 hours, about 35 hours, about 40 hours, or about 45 hours, about 50 hours, about 55 hours, about 60 hours, about 65 hours, about 70 hours, or about 72 hours.

In some embodiments, the incubation period can be executed at a temperature of at least about 20° C., at least about 25° C., at least about 30° C., at least about 35° C., at least about 60° C., or at least about 45° C. In some embodiments, the incubation period can be executed at a temperature of no more than about 50° C., no more than about 45° C., no more than about 40° C., no more than about 35° C., no more than about 30° C., or no more than about 25° C.

Combinations of the above-referenced temperatures are also possible for the incubation period (e.g., at least about 20° C. to no more than about 50° C., or at least about 25° C. to no more than about 45° C.), inclusive of all values and ranges therebetween.

In some embodiments, the incubation period can be executed at a temperature of about 20° C., about 25° C., about 30° C., about 35° C., about 40° C., or about 45° C.

In some embodiments, the incubation period can be executed at a relative humidity of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%. In some embodiments, the incubation period can be executed at a relative humidity of no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10%.

Combinations of the above-referenced relative humidity are also possible for the incubation period (e.g., at least about 5% to no more than about 95%, or at least about 10% to no more than about 90%), inclusive of all values and ranges therebetween.

In some embodiments, the incubation period can be executed at a relative humidity of about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%.

Applications

The methods and compositions disclosed herein can be used for a wide range of aquatic treatments. For example, the methods and compositions disclosed herein can be used in the shrimp industry. One aspect of the disclosure relates to a method of inhibiting bacteria in water, the method comprising contacting water with the fermented composition described herein. In some embodiments, the bacteria can include gram-positive bacteria. In some embodiments, the bacteria can include green Vibrio. In some embodiments, the bacteria can include pathogenic bacteria. In some embodiments, the pathogenic bacteria can include Vibrio parahaemolyticus, Vibrio anguillarum, Vibrio harvyi, Vibrio vulnificus, Aliivibrio salmonicida, Photobacterium damselae, Aeromonas caviae, Aeromonas hydrophila, Aeromonas sobria, Aeromonas veronii, Aeromonas jandaei, Edwardsiella anguillarum, Edwardsiella ictahri, Edwardsiella piscicida, Edwardsiella tarda, Yersinia ruckeri, Francisella noatunensis, Mycobacterium fortuitum, Mycobacterium marinum, Nocardia asteroidws, Nocardia crassostreae, Nocardia seriolae, Streptococcus agalactiae, Streptococcus iniae, Lactococcus garvieae, Aerococcus viridans, Renibacterium salmoninarun, Enterobacterium catenabicterium, Clostridium botulinur, Piscirickettsia salmonis, Hepatobacter penaei, Francisella noatunensis, Chlamydia spp, or any combination thereof.

In some embodiments, inhibiting pathogenic bacteria can mean no change or substantially no change in the pathogenic bacteria's CFU after the water is contacted with the fermented composition. In other words, the CFU value measured after the introduction of the fermented composition can be the same or substantially the same as CFU value measured before the introduction of the fermented composition. In some embodiments, inhibiting pathogenic bacteria can include a reduction in the amount of recovered pathogens by at least about 90%, at least about 95%, at least about 96%, at least about 97%, least about 98%, at least about 99%, at least about 99.5%, least about 99.9%, or at least about 99.99%, at least about 99.991%, at least about 99.992%, at least about 99.993%, at least about 99.994%, at least about 99.995%, at least about 99.996%, at least about 99.997%, at least about 99.998%, at least about 99.999%, inclusive of all values and ranges therebetween, as compared to a control group not subject to treatment with the methods and fermented compositions described herein.

The methods and compositions disclosed herein can be used for aquaculture systems including, but not limited to, a pond, a pool, a lagoon, an estuary, a shrimp farm and an enclosed area in the ocean. In some embodiments, the method can increase survivability of aquatic animals by at least 5% as compared to a control where the aforementioned compositions and methods are not used. In some embodiments, the method can increase survivability of the aquatic animals by at least 6%, at least 7%, at least 8%, at least 90%, at least 10%, at least 20%, at least 30%, at least 40%, or at least 50% as compared to a control where aforementioned compositions and methods are not used. In some embodiments, the method can increase survivability of the aquatic animals by about 10% to 200% as compared to a control where the aforementioned compositions and methods are not used. Examples of the aquatic animals can include, but are not limited to finfish (e.g., tilapia or catfish) and other fish species. Further examples of the aquatic animals can include, but are not limited to shrimp and other crustaceans.

Although methods and materials similar or equivalent to those described herein can be used in the practice or testing of the present invention, illustrative methods and materials are now described. Other features, objects, and advantages of the invention will be apparent from the description and from the claims. In the specification and the appended claims, the singular forms also include the plural unless the context clearly dictates otherwise. Unless defined otherwise, all technical and scientific terms used herein have the same meaning as commonly understood by one of ordinary skill in the art to which this invention belongs. All patents and publications cited in this specification are incorporated herein by reference in their entireties.

### Definitions

The term “comprising” as used herein is synonymous with “including” or “containing” and is inclusive or open-ended and does not exclude additional, unrecited members, elements or method steps. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The articles “a” and “an” are used in this disclosure to refer to one or more than one (i.e., to at least one) of the grammatical object of the article. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

The term “about” means within +10/c of a given value or range.

The term “wt %” means weight percentage.

The term “room temperature” means a temperature of about 15° C., about 16° C., about 17° C., about 18° C., about 19° C., about 20° C., about 21° C., about 22° C., about 23° C., about 24° C., or about 25° C. In some embodiments, the room temperature is about 20° C.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

### EXAMPLES

The disclosure is further illustrated by the following examples, which are not to be construed as limiting this disclosure in scope or spirit to the specific procedures herein described. It is to be understood that the examples are provided to illustrate certain embodiments and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

### Example 1. Fermentation of Soybeans

A composition was prepared as follows:
3 L Water
1 kg raw Soybeans
50 g pasteurized molasses
5 g of a mixed lactic-acid-producing bacteria and bacillus composition:
   95.45% Dextrose Monohydrate
   4% Diatomaceous Earth
   0.4% of a 1:1:1 mix of Lactobacillus plantarum, Pediococcus acidilactici, and Pediococcus pentosaceus at a total bacterial titer ≥100 billion CFU/g
   0.15% of a Bacillus subtilis 34KLB composition with a total bacterial titer ≥50 billion CFU/g
2.5 g mineral mix
Enzyme (phytase at 1 mL)

The soybeans were ground and cooked in boiling water for approximately 15 minutes. Then the molasses was added and the mixture was allowed to cool to ambient temperature. Once cooled, the remaining ingredients were added with mixing, and the mixture was allowed to ferment for 24 hours at ambient conditions. After fermentation, the solids were collected and fed to vibrio infected shrimp on feeding trays or broadcast at approximately 5%-25% of the total feed ration. The supernatant from the ferment was collected and sprayed onto traditional feed pellets and fed as part of the overall feeding regimen. Within 7-days, ponds treated by this protocol showed reduced levels of vibrio and the shrimp show no signs of vibriosis compared to untreated ponds.

### Example 2: Soybean Meal Fermentation

In this set of experiments, fermentations were conducted at 600 ml, 750 ml, and 1,000 ml. Recipes were as follows:

TABLE 2
Recipes used for Composition

| | | |
|---|---|---|
| 600 ml | 750 ml | 1000 ml |

| | | | | | | |
|---|---|---|---|---|---|---|
| Soybean Meal | 167 | g | 167 | g | 167 | g |
| Molasses | 1.25 | g | 1.25 | g | 1.25 | g |
| Mineral Mixture | 0.003 | g | 0.003 | g | 0.003 | g |
| lactic-acid-producing | 0.013 | g | 0.013 | g | 0.013 | g |
| bacteria and bacillus | | | | | | |
| composition | | | | | | |

Water was brought to a rolling boil, then soybean meal and molasses were added. Mixture was “cooked (kept up temperature so that mixture bubbled)” for 20-25 minutes with constant stirring. Mixture was cooled to room temperature, then remaining ingredients were added with mixing. Stationary fermentations were done at ambient temperature for 24 hours. Sampling for plate counts was done every 12 hours.

The 600 ml ferment did not support very good growth of either the Bacillus or lactic-acid-producing bacteria.

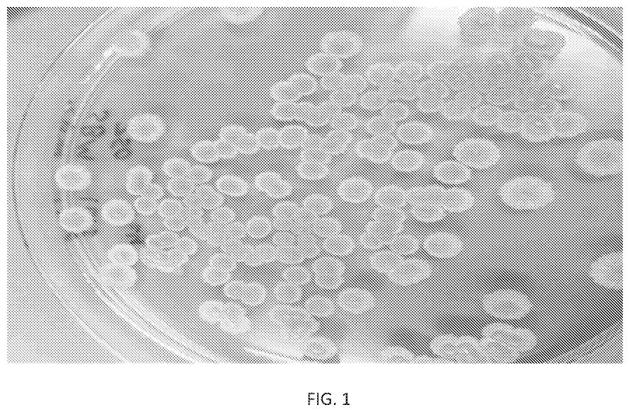

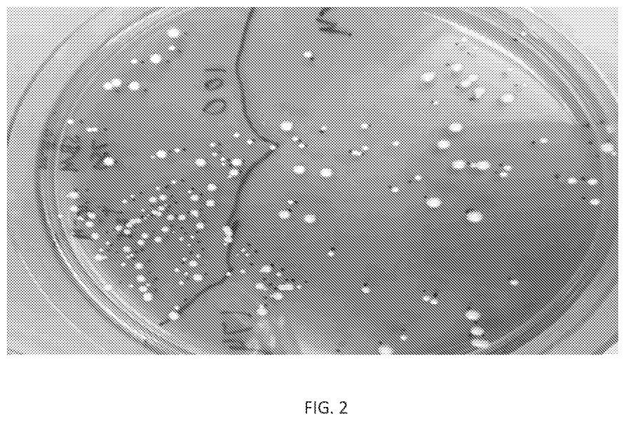

The 750 ml ferment showed good growth of Bacillus and lactic-acid-producing bacteria. Activity at 24h after fermentation was 1×10⁷ CFU/g for Bacillus and 2×10⁶ cfu/g for lactic-acid-producing bacteria (FIG. 1 and FIG. 2).

The 1,000 ml ferment supported lactic-acid-producing bacteria growth very well. Bacillus also grew, but not as well as in the 750 ml ferment. There was water standing on the top of the soybean meal during fermentation. Activity after 24 h fermentation was 7×10⁷ CFU/g for the lactic-acid-producing bacteria and 4×10⁶ CFU/g for Bacillus.

### Example 3: Soybean Meal Fermentation

In this experiment, the intention was to determine how much “cooking” of the soybean meal and molasses was required to keep the background microbiota from growing so that the added lactic-acid-producing bacteria and Bacillus could dominate the fermentation. 600 ml and 750 ml compositions were used. Water was brought to a rolling boil, then soybean meal and molasses were added with constant stirring to prevent burning. Samples of the ferments were collected every 5 minutes from onset of adding the soybean meal and molasses until T=20 minutes. Each ferment was also observed cold to determine what the background microbial levels were for each.

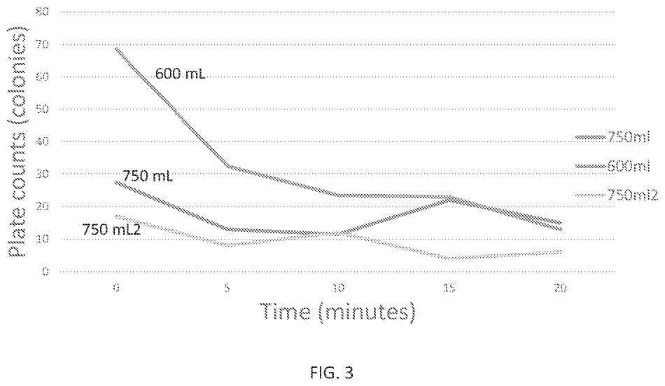

Background contaminates brought in with the soybean meal and molasses were on the order of 6×10² CFU/g for all 3 cold ferments. Additionally, it was observed that 20 minutes of “cooking” the soybean meal and molasses reduce the background contaminates enough to encourage growth of the added lactic-acid-producing bacteria and bacillus organisms, as shown in FIG. 3. The amount of water can also an important factor in helping to reduce background contaminates. Less water does not allow for complete “cooking” of the materials. 750 ml of water seems to be the threshold for getting a good fermentation of soybean meal and molasses.

### Example 4: Incubation of Fermentation

This experiment was intended to mimic a warm, humid climate such as might be found in parts of Asia. 750 ml and 1000 ml fermentations were run in accordance with Example 2, then placed them in an incubator at 30-35° C., with some humidity (unknown) for 24 h. Fermentations were carried out as outlined above with cooking soybean meal and molasses, cooling, then adding in remaining ingredients. Samples were collected every 6 hours and plated—TSA for Bacillus and MRS for lactic-acid-producing bacteria.

Incubation at 30-35° C. increased total titer in the 750 ml ferment but not in the 1000 ml ferment. T=24 hour counts for both Bacillus and lactic-acid-producing bacteria were 3×10⁸ and 1×10⁹, respectively.

### Example 5: Inhibition of V. parahaemolyticus

Inhibitory properties of the lactic-acid-producing bacteria/Bacillus mixture fermentations against gram-positive bacteria were observed, particularly Vibrio parahaemolyticus, the causative agent of Early Mortality Syndrome in shrimp production. Vibrio parahaemolyticus (ATCC® 27519™) was isolated from diseased shrimp. Culture was re-constituted in Marine Broth (Difco 2216) and grown at 37° C. for 24-48 hours.

TABLE 3
Soybean Meal Fermentations

| | Control Composition | | Treatment Composition | |
|---|---|---|---|---|
| Water | 750 | ml | 750 | ml |
| Soybean Meal | 167 | g | 167 | g |
| Molasses | 1.25 | g | 1.25 | g |
| Lactic-acid-producing | 0 | g | 0.013 | g |
| bacteria/Bacillus | | | | |
| composition | | | | |
| Mineral Mixture | 0.003 | g | 0.003 | g |

The treatment composition in Table 3 is referred to herein as the “Treatment Composition.”

Water was brought to a rolling boil, soybean meal and molasses were added. Mixture was cooked for 20 minutes, then cooled. Once cooled, remaining ingredients were added. Control plates (no lactic-acid-producing bacteria/Bacillus mix) were done on both TSA and MRS to confirm cooking inhibited background microbiota prior to addition of the lactic-acid-producing bacteria and Bacillus organisms. The lactic-acid-producing bacteria/Bacillus composition from Example 1 was added to treatment fermentation, and T=0 samples were plated on TSA and MRS for confirmation of organisms. Fermentations were covered with plastic wrap and foil, then left on bench for 24 hours.

40-gram samples of each ferment were collected in 50 ml conical tubes, spun down at 5,000 rpm for 15 minutes. Cured TSA plates, 12 each for control and treatment, were split down the middle, ½ for solids and the other ½ for supernatant. 10-ul of supernatant was place in center of ½ plate. Supernatant was then poured off to allow access to solids. Using a 1000-ul pipet tip, solids were mixed, then a small piece of solids was “smeared” onto the other % of plate in center. Plates were incubated at 35-37° C. overnight.

Soft agar tubes were prepared prior to the inhibition assay. Tubes were placed in a boiling water bath to soften agar. Once, molten, 3 tubes were then placed in a 55° C. bead bath to keep them molten. 200-ul of Vibrio parahaemolyticus broth culture was added to each tube and vortexed for 5 seconds. Tube was then poured around edge of TSA plate with solids/supernatant, allowing for spreading. Once agar solidified, plates were inverted and left on benchtop to grow, preventing swarming of Vibrio and Bacillus. Zones were then measured at 48 hours.

Three out of the 12 control plates showed some inhibition whereas all 12 plates of the treatment leg inhibited Vibrio parahaemolyticus.

Clearance zones were measured, and statistical analysis performed using a T-test for 2 samples assuming unequal variances. Data shows a statistical difference (p<0.05) between the control versus the treatment.

TABLE 4
Statistical Analysis

| | Mean Clearing | | |
|---|---|---|---|
| | Zone Diameter | Variance | P Value |
| Control | 0.18 cm | 0.15 cm | |
| Supernatant | | | |
| Control Solid | 0.31 cm | 0.56 cm | |
| Treatment | 1.55 cm | 0.94 cm | 0.0002 |
| Supernatant | | | |
| Treatment Solid | 1.67 cm | 0.72 cm | 1.5E−05 |

750 ml fermentation continually showed growth of the lactic-acid-producing bacteria and Bacillus organisms of the invention. The lactic-acid-producing bacteria/Bacillus composition inhibits Vibrio parahaemolyticus in plate inhibition assays.

### Example 6: Inhibition of Vibrio hareyi

A culture of V. harveyi (ATCC® 33867™) was re-constituted in Marine Broth (Difco 2216) and grown at 37° C. for 24-48 hours. Conditions for soy fermentations and inhibition assays were the same as those described in Example 5.

TABLE 5
Statistical Analysis

| | Mean Clearing | | |
|---|---|---|---|
| | Zone Diameter | Variance | p Value |
| Control Supernatant | 0.29 cm | 0.93 | |
| Soy Ferment | 1.29 | 0.28 | 0.009 |
| Supernatant with the | | | |
| Treatment | | | |
| Composition | | | |
| Soy Ferment solids | 1.79 | 0.27 | 0.0004 |
| with the Treatment | | | |
| Composition | | | |
| Control Solid | 0.56 | 0.66 | |
| Soy Ferment solids | 1.79 | 0.27 | 0.0006 |
| with the Treatment | | | |
| Composition | | | |

### Example 7: Inhibition of Vibrio vulnificus

Cultures of V. vulnificus (ATCC® 33149™) were re-constituted in Marine Broth (Difco 2216) and grown at 37° C. for 24-48 hours. Conditions for soy fermentations and inhibition assays were the same as those described in Example 5.

TABLE 6
Statistical Analysis

| | Mean Clearing | | |
|---|---|---|---|
| | Zone Diameter | Variance | p Value |
| Control Supernatant | 0.19 cm | 0.42 | |
| Soy Ferment | 1.47 cm | 2.28 | 0.008 |
| Supernatant with the | | | |
| Treatment | | | |
| Composition | | | |
| Control Solid | 0.52 cm | 0.95 | |
| Soy Ferment solids | 1.47 cm | 2.28 | 0.06 |
| with Treatment | | | |
| Composition | | | |

### Example 8: Inhibition of Vibrio cholerae

Cultures of V. cholerae (ATCC® 582™) were re-constituted in Marine Broth (Difco 2216) and grown at 37° C. for 24-48 hours. Conditions for soy fermentations and inhibition assays were the same as those described in Example 5.

TABLE 7
Statistical Analysis

| | Mean Clearing | | |
|---|---|---|---|
| | Zone Diameter | Variance | p Value |
| Control Supernatant | 0.94 cm | 0.61 | |
| Soy Ferment | 2.59 cm | 2.21 | 0.003 |
| Supernatant with the | | | |
| Treatment | | | |
| Composition | | | |
| Soy Ferment solids | 4.92 cm | 5.14 | 0.00005 |
| with the Treatment | | | |
| Composition | | | |
| Control Solid | 2.97 cm | 9.20 | |
| Soy Ferment solids | 4.92 cm | 5.14 | 0.09 |
| with the Treatment | | | |
| Composition | | | |

### Example 9: Inhibition of Vibrio anguillarum

Cultures of V. anguillarum (ATCC® 19264™) were re-constituted in Tryptic Soy Broth (Difco 211825) and grown at 27° C. for 24-48 hours. Conditions for soy fermentations and inhibition assays were the same as those described in Example 5.

TABLE 8
Statistical Analysis

| | Mean Clearing | | |
|---|---|---|---|
| | Zone Diameter | Variance | p Value |
| Control Supernatant | 0.27 cm | 0.29 | |
| Soy Ferment | 1.32 cm | 0.13 | 0.00003 |
| Supernatant with the | | | |
| Treatment | | | |
| Composition | | | |
| Soy Ferment solids | 1.46 cm | 0.48 | 0.0002 |
| with the Treatment | | | |
| Composition | | | |
| Control Solid | 0 | 0 | |
| Soy Ferment | 1.32 cm | 0.13 | 2.8 × 10⁻⁷ |
| Supernatant with the | | | |
| Treatment | | | |
| Composition | | | |
| Soy Ferment solids | 1.46 cm | 0.48 | 0.00004 |
| with the Treatment | | | |
| Composition | | | |

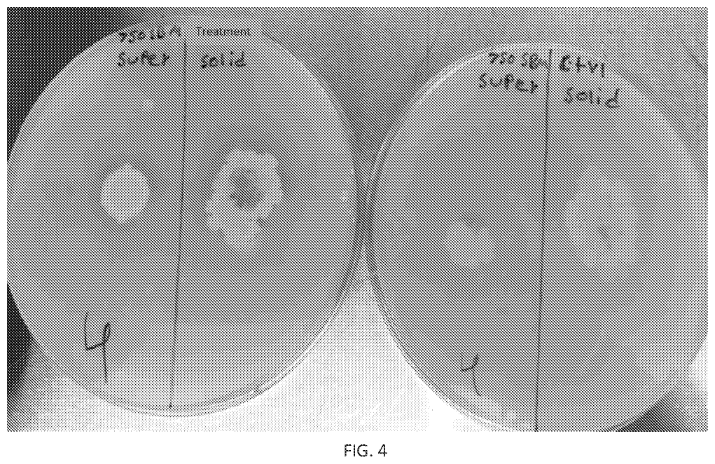

Examples of inhibition of various bacterial species are shown in FIGS. 4-8B, as described below.

FIG. 4 shows inhibition of V. parahaemolyticus from both the supernatant (left hand side of each plate) and solid portion (right hand side of each plate) of soy meal fermented with the claimed microbial composition (left hand plate) versus a control treatment of soy meal fermented without the Treatment Composition (right hand plate).

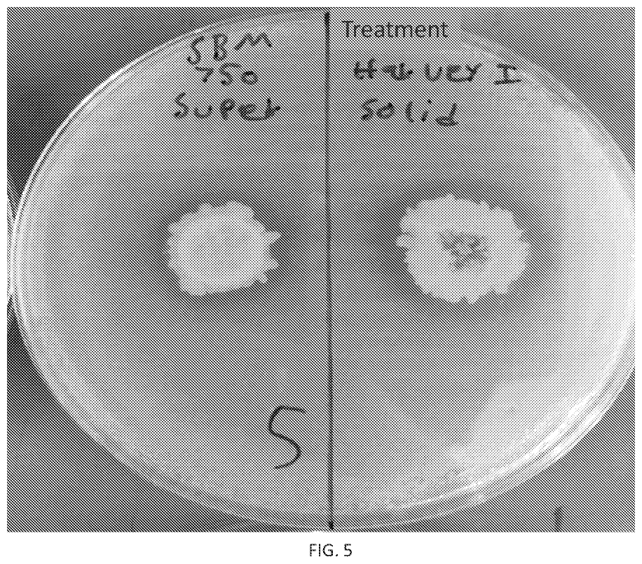

FIG. 5 shows inhibition of V. harveyi from both the supernatant (left hand side of the plate) and solid portion (right hand side of the plate) of soy meal fermented with the Treatment Composition.

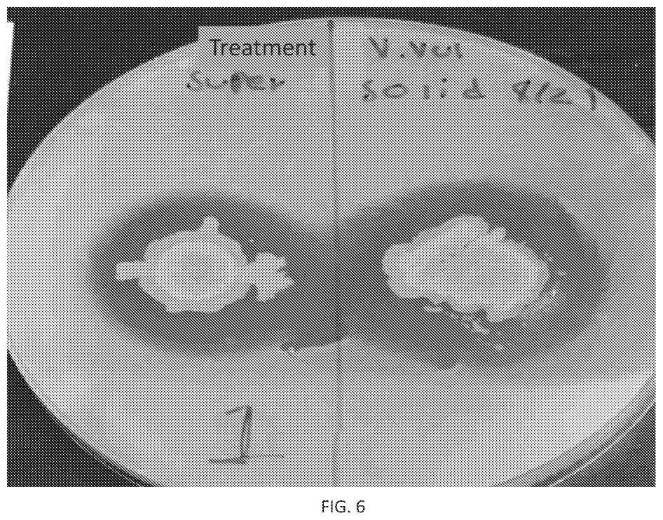

FIG. 6 shows inhibition of V. vulnificus from both the supernatant (left hand side of the plate) and solid portion (right hand side of the plate) of soy meal fermented with the Treatment Composition.

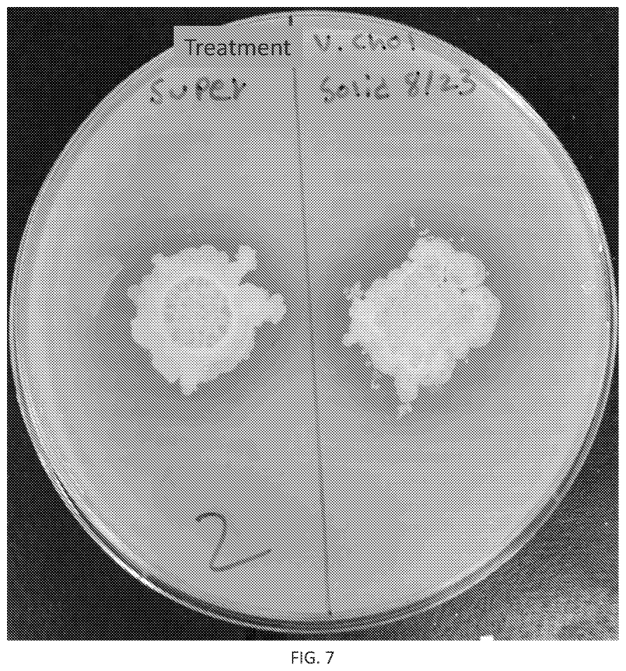

FIG. 7 shows inhibition of V. cholerae from both the supernatant (left hand side of the plate) and solid portion (right hand side of the plate) of soy meal fermented with the Treatment Composition.

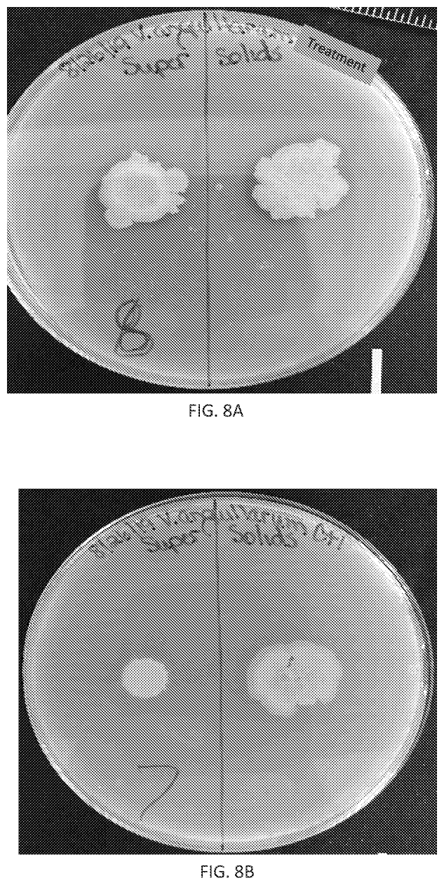

FIGS. 8A and 8B show inhibition of V. anguillarum from both the supernatant (left hand side of each plate) and solid portion (right hand side of each plate) of soy meal fermented with the microbial composition described herein (FIG. 8A) versus a control treatment of soy meal fermented without the Treatment Composition (FIG. 8B).

### Example 10: Immersion Challenge with Acute Hepatopancreatic Necrosis Disease

Soy meal fermented with the claimed microbial composition was tested on juvenile shrimp, Penaeus vannamei challenged with Acute Hepatopancreatic Necrosis Disease (AHPND) as a result of infection with V. parahaemolyticus. The trial was conducted for 26 days which included a 1-day adaptation period, 14 days feeding treatment diets, a 1-day challenge with V. parahaemolyticus, followed by 10 days post challenge monitoring. The trial was designed with 3 groups, with 3 replicates each in a completely randomized design. Tanks were stocked with 25 shrimp/tank (250 pcs/m³ equivalent).

TABLE 9
Soybean Meal Fermentation

| | Treatment 1 | |
|---|---|---|
| Water | 750 | ml |
| Soybean Meal/Whole ground soybean | 167 | g |
| Molasses | 1.25 | g |
| Lactic-acid-producing bacteria/ | 0.013 | g |
| Bacillus composition | | |
| Mineral Mixture | 0.003 | g |

Water was brought to a rolling boil, soybean meal and molasses were added. Mixture was cooked for 20 minutes, then cooled. Once cooled, remaining ingredients were added, ferment was covered and left on bench for 24 hours at ambient temperatures. Ferment was then dried, ground and mixed with the basal diet at 20%/kg feed (w/w) and supplied in the post-challenge diet. Both Positive and Negative controls received the basal diet with no soybean ferment. Shrimp were fed ad libitum their respective diets 4 times per day during trial.

Lethal Dose 50 (LD₅₀) of 1.2×10⁵ CFU/mL and Lethal Dose 80 (LD₈₀) of 8.0×10⁵ CFU/mL Vibrio parahaemolyticus isolate VPLA-1 was used in the 1-day immersion challenge. Tryptic Soy Broth+2% sodium chloride (TSB+) was inoculated with the Vibrio isolate and incubated for 24 hours. Bacterial suspension was then added into tanks to achieve the bacterial density, measured by optical density absorbance (OD600 nm), expected to kill 50% and 80%% in the negative control within 10 days. Positive control tanks were treated with placebo (sterile TSB+).

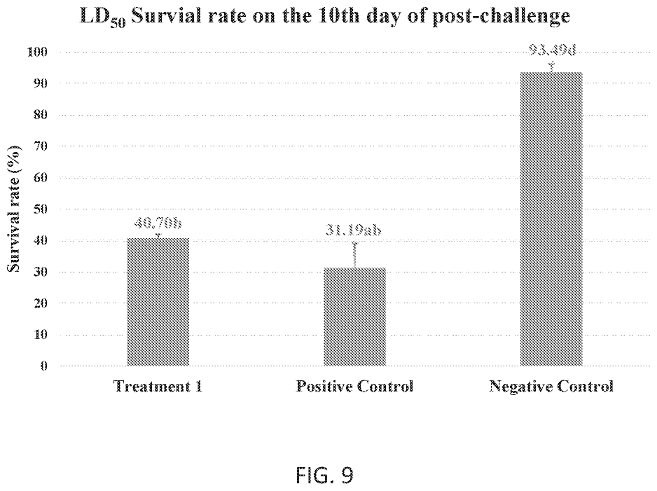

LD₅₀ survival: Survival rates (%) for Soy Ferment treatment were 40.70±1.22; Negative Control 31.19±7.84, Positive Control 93.49±2.61 (FIG. 9).

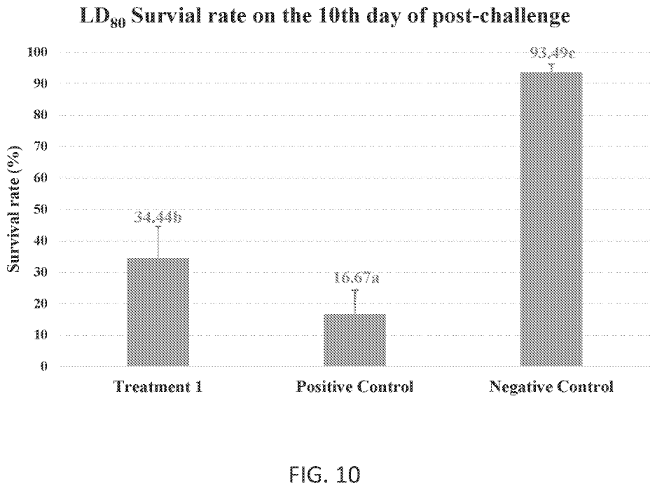

LD₈₀ survival: Survival rates (%) for Soy Ferment treatment were 34.44±10.05; Negative Control 16.67±7.64, Positive Control 93.49±2.61 (FIG. 10).

### EQUIVALENTS

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

1. A composition comprising:
water;
soybean;
molasses;
a mineral mixture;
an enzyme; and
a microbial mixture comprising Lactobacillus plantarum, Pediococcus acidilactici, Pediococcus pentosaceus, and Bacillus subtilis 34KLB.

2. The composition of claim 1, wherein Lactobacillus plantarum, Pediococcus acidilactici, and Pediococcus pentosaceus are present at a ratio of about 1:1:1 by colony-forming unit (CFU).

3. The composition of claim 1 or 2, wherein Lactobacillus plantarum, Pediococcus acidilactici, and Pediococcus pentosaceus are present in the microbial mixture at equal to or greater than 1×10⁸ CFU per gram of the microbial mixture.

4. The composition of any one of claims 1-3, wherein Bacillus subtilis 34KLB is present in the microbial mixture at equal to or greater than 10⁶ CFU per gram of the microbial mixture.

5. The composition of any one of claims 1-4, wherein the microbial mixture further comprises a water-soluble diluent.

6. The composition of claim 5, wherein the water-soluble diluent is selected from dextrose monohydrate, anhydrous dextrose, sucrose, maltose, maltodextrin, sodium chloride, potassium chloride, calcium chloride, magnesium chloride, sodium sulfate, potassium sulfate, sodium bicarbonate, sodium carbonate, and magnesium sulfate.

7. The composition of claim 6, wherein the microbial mixture comprises about 95.45 wt % dextrose monohydrate, about 4 wt % diatomaceous earth, about 0.4 wt % Lactobacillus plantarum, Pediococcus acidilactici, and Pediococcus pentosaceus, and about 0.15 wt % Bacillus subtilis 34KLB.

8. The composition of any one of claims 1-7, wherein the mineral mixture comprises about 64.15 wt % dipotassium phosphate, about 20 wt % calcium propionate, about 4.5 wt % gemstone manganese, about 3.1 wt % gemstone iron, about 2.8 wt % gemstone copper, about 2.7 wt % gemstone zinc, about 2.67 wt % selenium yeast 3000, and about 0.08 wt % cobalt sulfate monohydrate.

9. The composition of any one of claims 1-8, wherein the enzyme is selected from phytase, protease, amylase, cellulase, cellobiohydrolase, endoglucanase, exoglucanase, and lipase.

10. The composition of any one of claims 1-9, wherein the soybean is raw soybean.

11. The composition of any one of claims 1-9, wherein the soybean is soybean meal.

12. The composition of claim 10, wherein the weight ratio of water, raw soybean, molasses, the mineral mixture, and the microbial mixture is about 3000:1000:50:2.5:5.

13. The composition of claim 11, wherein the weight ratio of water, soybean meal, molasses, the mineral mixture, and the microbial mixture is about 1000:167:1.25:0.003:0.013.

14. A composition comprising:
water;
soybean;
molasses;
a mineral mixture;
an enzyme; and
a microbial mixture comprising a Bacillus composition.

15. The composition of claim 14, wherein the Bacillus composition comprises Bacillus subtilis 34KLB.

16. The composition of claim 15, wherein the Bacillus composition further comprises Bacillus amyloliquefaciens.

17. A method of preparing a fermented composition of the composition of any one of claims 1-16, the method comprising:
boiling the water in a container;
adding the soybean and molasses to the boiling water;
stirring the soybean and molasses for at least 20 minutes;
cooling the soybean, molasses, and water to room temperature;
mixing the mineral mixture, the enzyme, and the microbial mixture into the water, wherein the water is substantially free of stirring motions for at least 20 hours.

18. The method of claim 17, wherein the soybean and molasses are stirred for less than or equal to 30 minutes.

19. The method of claim 17 or 18, wherein the cooling step comprises contacting the container with ice.

20. The method of any one of claims 17-19, wherein the water is substantially free of stirring motions for less than or equal to 48 hours.

21. A fermented composition produced by the method of any one of claims 17-20.

22. A method of inhibiting pathogenic bacteria in water, the method comprising contacting water with the fermented composition of claim 21.

23. The method of claim 22, wherein the pathogenic bacteria is selected from Vibrio parahaemolyticus, Vibrio anguillarum, Vibrio harveyi, Vibrio vulnificus, Aliivibrio salmonicida, Photobacterium damselae, Aeromonas caviae, Aeromonas hydrophila, Aeromonas sobria, Aeromonas veronii, Aeromonas jandaei, Edwardsiella anguillarum, Edwardsiella ictaluri, Edwardsiella piscicida, Edwardsiella tarda, Yersinia ruckeri, Francisella noatunensis, Mycobacterium fortuitum, Mycobacterium marinum, Nocardia asteroidws, Nocardia crassostreae, Nocardia senolae, Streptococcus agalactiae, Streptococcus iniae, Lactococcus garvieae, Aerococcus viridans, Renibacterium salmoninarum, Enterobacterium catenabicterium, Clostridium botulinum, Piscirickettsia salmonis, Hepatobacter penaei, Francisella noatunensis, and Chlamydia spp.

24. The method of claim 22 or 23, wherein the water is used in aquaculture.
